(19) United States
(12) Patent Application Publication
(10) Pub. No.: US 2016/0162444 A1
(43) Pub. Date: Jun. 9, 2016

(54) System and Method for Adding Visitor Content to a Page

(71) Applicants: Matthew Zimmer, Lexington, KY (US); Aaron Stringer, Lexington, KY (US); Adam Whitehouse, Lexington, KY (US)

(72) Inventors: Matthew Zimmer, Lexington, KY (US); Aaron Stringer, Lexington, KY (US); Adam Whitehouse, Lexington, KY (US)

(73) Assignee: Falcon Client Services, LLC, Lexington, KY (US)

(21) Appl. No.: 14/955,216

(22) Filed: Dec. 1, 2015

Related U.S. Application Data
(60) Provisional application No. 62/088,588, filed on Dec. 6, 2014.

(51) Int. Cl. G06F 17/21; G06F 3/0484

(52) U.S. Cl. CPC G06F 17/212; G06F 3/04842; G06F 3/04847

(57) ABSTRACT

Computer-implemented methods for adding story content to a web site are provided. In one aspect, a computer-implemented method provides for visitors to a website or single-page application (SPA) to add content to a website or SPA based on a storytelling rule set. In another aspect, a computer-implemented method provides for visitors to a website or SPA to add content of a type within a frame of the same type.

### CROSS-REFERENCE TO RELATED APPLICATIONS

This application claims the benefit of U.S. Provisional Patent Application #62088588, filed Dec. 6, 2014, the contents of which are incorporated herein by reference. The present invention was a result of activities undertaken within the scope of a joint development agreement between Falcon Client, LLC and Bluegrass Integrated Communications.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

Prior art methods for adding content to a website have included emailing digital content to a website administrator, or posting comments to a “comment” section of a website, wherein the comments will be listed in date order. In social media sites, photos or videos may be added, but the content is segmented to show the content was added by a visitor to stand on its own, not part of a larger narrative. The content added by a visitor will be perceived by a reader as separate content.

This has served the needs of users to an extent, but does not enable visitors to contribute to web content as if their content is part of an ongoing narrative by the author. What is needed is a system and method to enable a visitor to add content to a website that appears fully integrated into the original author's story content to increase the storytelling impact of the content.

### BRIEF SUMMARY

The invention is defined by the claims. The broader aspect of this invention pertains to a system and method of enabling a visitor to add integrated content to a page and, under the control of an administrator panel, the resultant story content increases the storytelling impact of the published outcome. The advantages will be apparent from the reading of the following detailed description and the associated drawings. It is to be understood that the foregoing description and the following detailed description are explanatory and do not restrict aspects as claimed.

### BRIEF DESCRIPTION OF THE DRAWINGS

The objects of this invention will become more apparent and the invention itself will be better understood by reference to the following description of an embodiment taken in conjunction with the accompany drawings wherein:

In the drawings:

FIG. 1 shows a pictorial flowchart for a storytelling content example.

FIG. 2a-c show the steps for adding content using the Adder Module

FIG. 3 shows a flowchart of adding content and the action of the admin page algorithm

FIG. 4 shows a flowchart of the action of a rule set

FIG. 5 shows how content is acted upon

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

Although the disclosure herein is described in the context of internet web functionality, it is to be understood that known variations such as an intranet, a Single Page Application (SPA), and like derivatives are considered functional equivalents for the application of the present disclosure, regardless of the use of the internet. Likewise, it is to be understood that content may be transferred by sending data from a local system to a remote system or by sending data within a local system. For the purposes of this disclosure, the sending of data may be referred to as either uploading or adding.

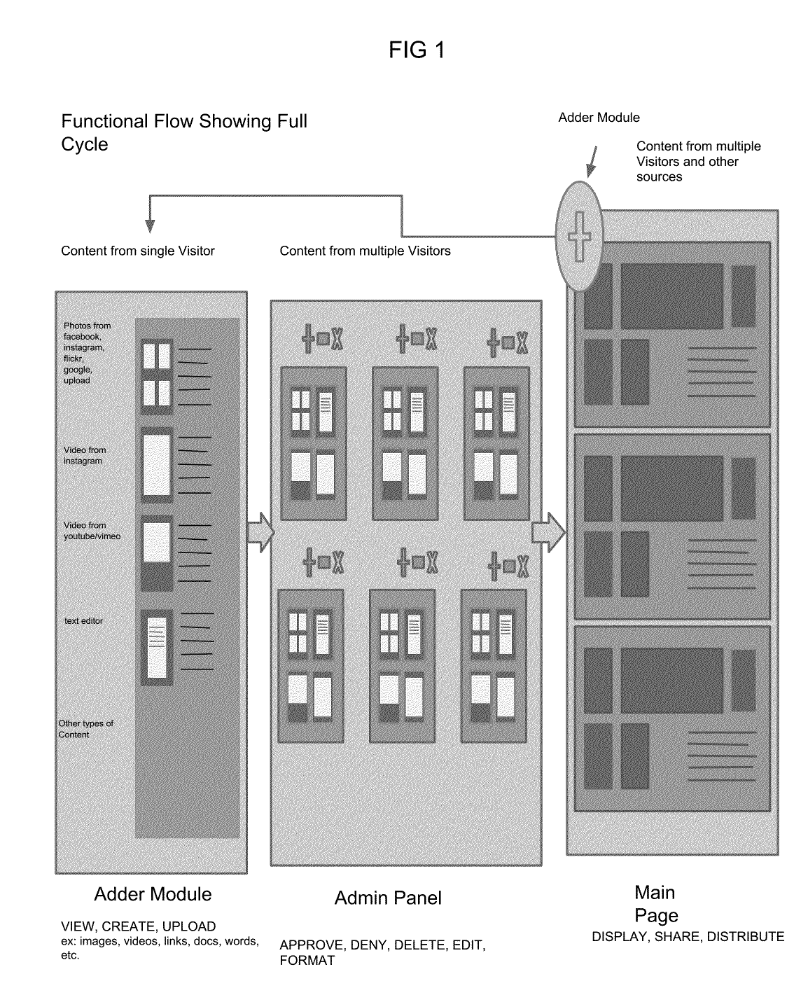

FIG. 1 shows a pictorial flowchart of visitor content being added to a webpage. There is shown an adder module that is accessible to one or more visitors having content which they wish to add to a page. An administrator panel receives the visitor content from the adder module wherein content is reviewed, edited, rejected, and the like by an administrator. The main page displays original content provided by an author in a format and also receives content from a visitor, approved by the administrator, then finally added to the original content in the same or similar format. The content added by a visitor which is then integrated into original content in the same or similar format is referred to as “integrated content”.

By way of example, a website may contain content from a wedding which was attended by many. These attendees may have thoughts or text comments to share about the wedding, and may have photos, video, or audio content as well. The adder module is accessed by visitors to share this content. The adder module simplifies the process of adding content to be integrated by providing commands for easy selection or a text editor for direct entry of text content. Depending on the content, the adder module may require certain tags to be associated with the content to be added. For example, a photo of the bride posing with “Uncle Mike” may be tagged to other photos of Uncle Mike which may be appropriately grouped. Alternately, the photo may include a time tag so that photos of Uncle Mike may be shown progressively through the story telling narrative from arrival at the wedding to his departure. The original content may include tags that are suggested to the visitor to avoid redundant or somewhat different tags. In addition, the adder module user interface may add cues and suggestions for the visitor based on already existing content, or simply which part of the main page the visitor is viewing then they add content. The suggestions may aid the visitor in determining what new content to add to enhance the storytelling effect of the eventually published content. Benefits of this intelligence may be in filling in gaps in the story by suggesting content of certain types of content or subject matter. For instance, pictures of Uncle Mike with the bride. Content added by a visitor will also contain information by its very nature such as source, type of content, image data, geo locating data, and the like. Each of these types of information can be used to provide context for increasing the storytelling impact as part of this invention.

Now referring to the Administrator Panel of FIG. 1, the figure shows content added by multiple visitors. There is no technical limitation to the number of visitors. The administration panel is normally restricted by a security measure, such as a password, fingerprint, iris image, voice signature, or other like security measure. An administrator controls what content is to be added to a Main Page, which is the page typically displayed to all readers. The administrator may approve, deny, edit, suggest changes to a visitor, and/or insert the content into a story form of their choosing. The administrator may rely in part or in whole on the semantic mapping algorithm used by a visitor, or may rely in part or in whole on a different semantic mapping algorithm to suggest insertion of content into the original story, as part of this disclosure.

Not shown in FIG. 1 is an optional permissions field assigned to visitors either individually or by groups. Depending on the supervisory needs of an individual or a group, the level of review required by an administrator may range from “none” to “high” with varying intermediate levels.

The administrator panel includes a storytelling rule set. Simply stated, the storytelling rule set analyzes the format of the original content, and the information inherent or added to the content, and guides the administrator in increasing the storytelling impact of the content, and ensuring the format of the original content is preserved within an acceptable tolerance.

The storytelling rule set analyzes the visitor's written content in addition to tags associated with the content and other information in the content. This algorithm may suggest a visitor's written text to be inserted between paragraphs three and four, for example, as a best fit to preserve the original author's intent. The visitor may be enabled to “approve” or “reject” this algorithm suggestion. The visitor may also be enabled to “approve with edits”, wherein the insertion of text between paragraphs three and four may be more appropriate with a change to the introductory sentence, for example. This algorithm may also suggest formats, arrangements, placements, styling and the like.

The disclosed SPA tracks information such as what part of the page the visitor viewed and what part the visitor was viewing when they added content, as well as other navigational information such as what parts of the page the visitor spent the most time viewing and what other links or page parts they visited and how they entered the site.

The Main Page shown in FIG. 1 shows the content added by one or more visitors, and approved by an administrator. The content approved by the administrator is integrated into the story format, thereby preserving the original intent of the author, and improving the reading experience of website visitors. The algorithm and the user of the administrator page work in concert to determine the size, type, placement, and format, among other factors to enhance the storytelling impact of the content. The main page may have content added once by one visitor, or many times by multiple visitors. Visitors are not limited to the number of times that content may be added.

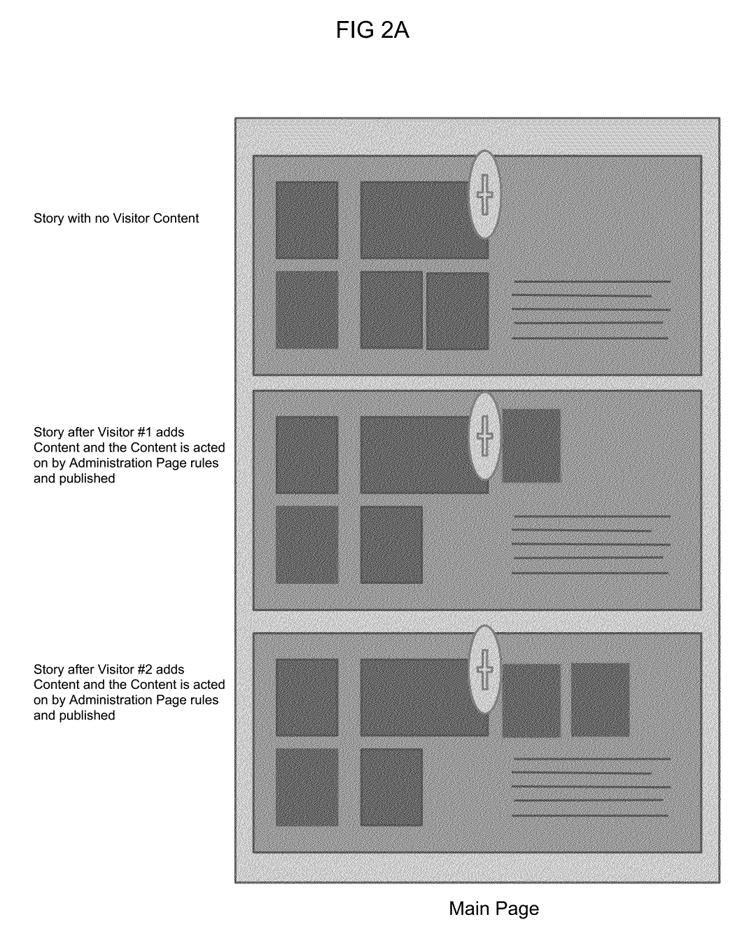

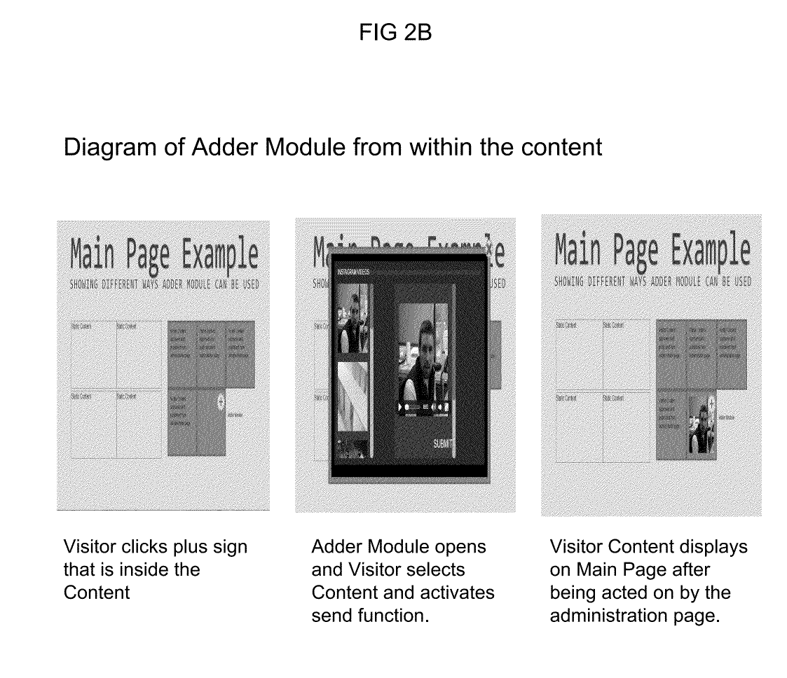

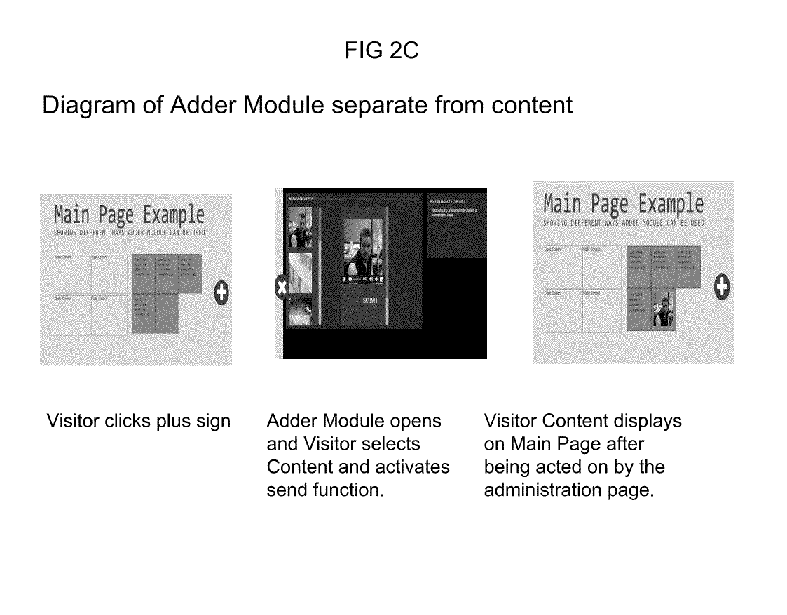

FIG. 2a illustrates original content having no visitor content, one visitor content, and two visitor content. FIG. 2b shows actual added content.

FIG. 2c illustrates an adder module. This module enables adding of like content within a frame. In the figure, photos are shown within a frame. A command button shown as a plus sign (although any image may be used) is shown. When the visitor selects the plus sign command button, like content may be added to within the frame.

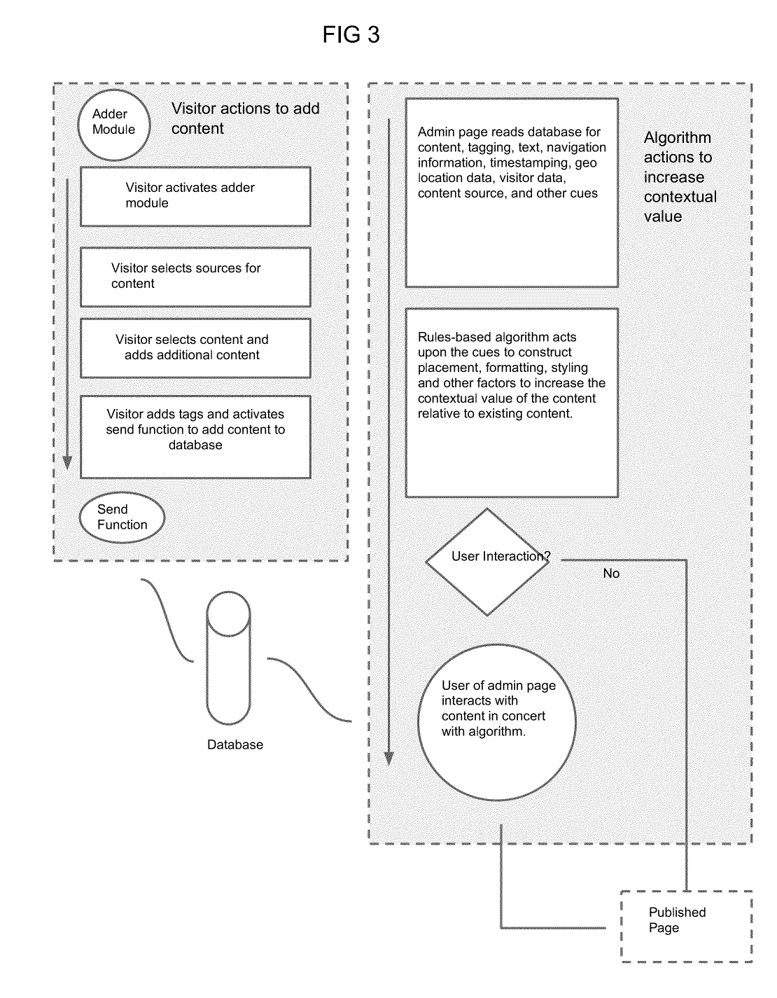

In FIG. 3, a flowchart of a storytelling rule set (“rule set”) is shown. This rule set is applied to a visitor's added content to provide cues for syncing new content with content on the main page. Once added, the rule set is applied to the admin page. In each instance, the rule set improves the adding of content to the original author's story content to increase the storytelling impact.

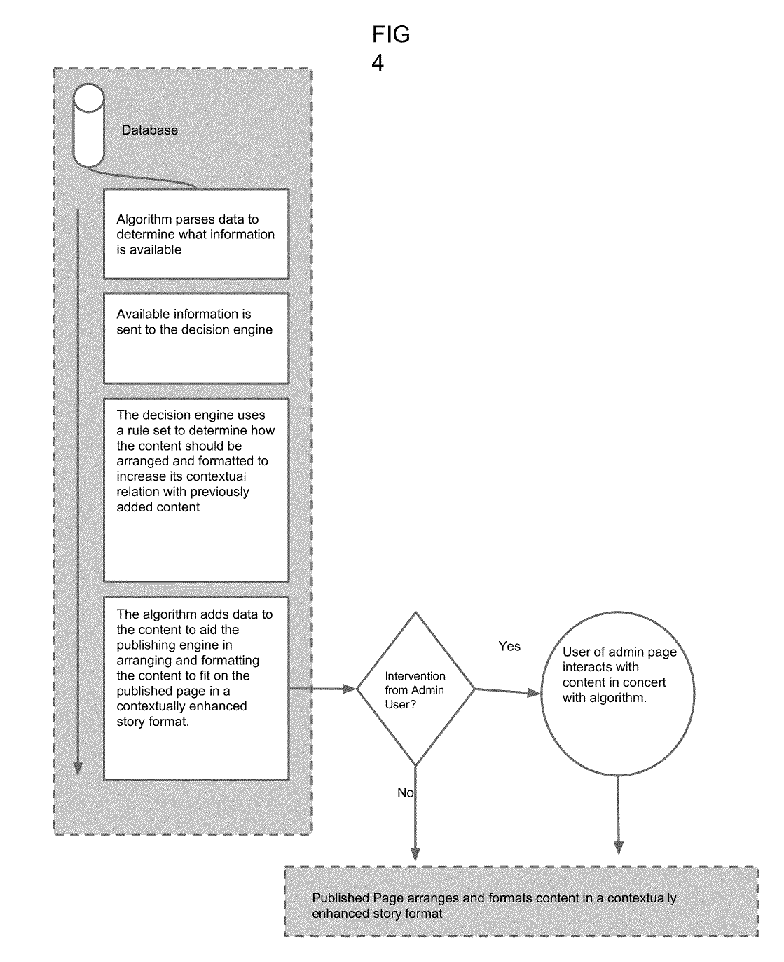

The action of the rule set is shown in FIG. 4 in which a decision engine relies on the rule set to provide suggestions to the administrator. This may be configured to publish as suggested by the decision engine with or without the administrator's approval.

The storytelling rule set comprises a set of rules that aid in the generation of a cohesive story by contextually arranging and formatting content aided by an algorithm. The algorithm relies on selective tagging by the author, image recognition techniques, page location practices and other cues that lead to intelligent contextualization of the content.

An implementation of this includes an algorithm which uses one or more of the following cues to aid in contextual storytelling.
Selective tagging by the visitor using the adder module. The tagging may be prompted by the adder module or determined solely by the visitor.
Detection of what part of the page the visitor was viewing when using the adder module to provide a cue for where the added content should be published.
Detection of what parts of the page, or other pages, the visitor navigated to provide cues on context.
Image detection to provide cues of what the content refers to.
Detection of the source from which the content is selected. i.e. social platforms, local computer storage, direct recording.
Detection of the type of content
Geo-tagging of photos and video
Recognizing an integration of text and tagged images.
Suggested phrases based on the format of the original content, or suggested tags for text, photos, or videos.
Leading phrases designed to suggest subject matter to the Visitor adding content.
   Example phrases are:
      “One thing that intrigued me was . . . ”
      “I knew this was a big deal when . . . ”
      “What I love about this is . . . . ”

To further the wedding example, an implementation of this concept would be, as an example:

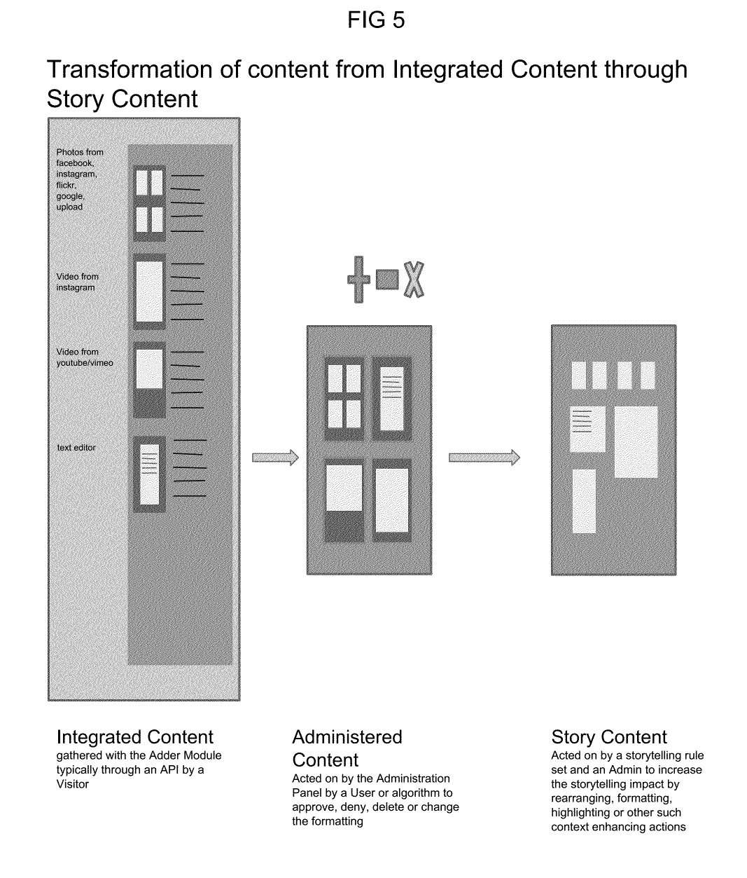

FIG. 5 shows depicts the following steps.

Content is generated by guests and participants in the wedding using smart phones, tablets, smart watches, cameras and other devices which capture digital content. Content would be added to the administrator page with the adder module described herein, as integrated content. An admin person could at that point approve, deny, or delete content to create administered content. The algorithm parses the content for cues from any tagging, image recognition, navigation, etc.

For instance, content may have the tag “reception”, added by the visitor, and an image of the bride and the bride's father is detected. The algorithm could also determine that the visitor was viewing the part of the main page displaying pictures and description of the dancing that has taken place. Further, the algorithm determines that the content is a video originally recorded using the Instagram video app. The algorithm could also use word recognition to analyze any description typed in by the visitor as further cues, whether prompted by the adder module or created independently by the visitor. The storytelling rule set would make an intelligent determination that this may represent a short video of the bride's dance with her father and would present it as such on the administration page. This would enable the user of the administration page to easily add it to the story contextually to enhance the story of the bride's dance with her father, making the overall page more cohesive and possibly more engaging. In like manner, all content uploaded could be scanned and presented on the administrator page to be accepted, denied, edited and otherwise formatted by the user of the administrator page to create contextually enhanced stories.

The content, thusly acted upon, could be published to the main page to build stories enhanced by content added by visitors. Prior to publishing, an opportunity is given to the user of the administration page to interact with the results of the algorithm to make edits and changes to the arrangement and formatting aided by the results of the algorithm.

The storytelling rule set is capable of recognizing text in the form of a narrative writing style, a timeline structure, and a bullet list. It is also capable of recognizing images by associated tags. Image recognition can be used as part of a rule set based on image type: for example faces, animals, landscapes, or event specific images. Using the wedding example further, the faces of the principles (bride, groom, family members, guests) can be scanned into one or more databases, or extracted from social platforms, and parsed by the administrator page rule set to make intelligent decisions about placement of content and content descriptions. Another example would be image recognition of products from a business product line. Further, the storytelling rule set is capable of recognizing an integration of text and tagged images. Tagging guidance can be presented to a visitor to aid in the accuracy of the rule algorithm. This rule set is capable of recognizing geo-tagged photos and video as well.

The storytelling rule set may rely on a semantic language analysis of the text.

An advantage of the storytelling rule set is that the storytelling analysis may result in suggestions provided to the visitors to improve the submitted content prior to review by the administrator. This may include suggested phrases based on the format of the original content, or suggested tags for text, photos, or videos.

Definitions

Visitor—a person who visits a page or other type of information display.

Page—any content that is available to a visitor or user, whether displayed or held in storage, typically, but not limited to, using the World Wide Web or functional equivalent.

Main Page—a page that enables Visitors to add content, upload content or display content using an adder module.

Content—elements such as words, images, videos, links to content, diagrams, documents, or other viewable material that contains information.

Adder Module—a functional module that enables the visitor to add, upload or directly display content.

Admin—a person who has login rights to an admin panel.

Admin Panel—a page separate from the main page that is typically restricted to use only by persons having the proper role authority and login access.

Send Command—a method for adding, uploading or directly displaying content.

Integrated Content—Content that has been sent using the adder module to the Admin Panel, typically by employing an API and a selection user interface

Administered Content—Integrated Content that has been acted on in the Admin Panel to the extent of approving, denying, or formatting the content

Story Content—Administered Content that has been altered in varying degrees by the storytelling rule set or by the Admin, or a combination.

Sync Method—A method by which content is altered to comply with one or more commands executed by a rule set or user.

1. A method for adding integrated content to a page, comprising:
a) at a main page, using a web browser, or like facility, executed by the visitor;
b) displaying in a first browser window a visitor authoring single page application (SPA), the visitor authoring SPA displaying a graphical user interface for composing content in the visitor defined SPA, and send command;
c) at a main page, composing content having a variable level of formatting, from one or sources, resulting in visitor content;
d) using the send command to add the visitor content to an administrator site;
e) displaying in a second browser window an administrator page, the administrator page displaying a graphical user interface for approving or rejecting content received by the administrator site, and for optionally formatting content received by the administrator site, and an administrator sync method;
f) at an administrator site, approving, rejecting, editing or formatting content received by the administrator site, resulting in administered content;
g) using the sync method, syncing the administered content to an application programming interface (API), wherein the API syncs the administered content with a storytelling rule set to conform the administered content to a storytelling format resulting in story content;
h) wherein the API syncs the administered content using a storytelling rule set including sorting and sometimes accompanied by filtering content resulting in story content;
i) wherein the API syncs the administered content using a storytelling rule set including from what part of the main page the visitor added the content;
j) wherein the API syncs the administered content using a storytelling rule set including cues from any words, comments, tags, other information, or any combination, that provides clues to the storytelling intent of the visitor;
k) wherein the API syncs the administered content using a storytelling rule set including navigational information such as what parts of the main page the visitor spent the most time viewing or what other links or page parts they visited or how they entered the site, or any combination of the above methods resulting in story content.

2. The method of claim 1, wherein at a main page, a graphical user interface enables the selection of content using an API.

3. The method of claim 1, wherein at a main page, a graphical user interface embedded as part of the existing content on the main page, enables the selection of content using an API

4. The method of claim 1, wherein at a main page a context variable graphical user interface provides cues which aids the visitor in adding content constructed to enhance the storytelling effect of the content.

5. The method of claim 1, wherein at a main page, a graphical user interface enables the selection of, by one or more visitors, including but not limited to visitors coincident in time or location, or any combination, resulting in content being added from one or more visitors, from one or more sources.

6. The method of claim 1, wherein at an administrator site an algorithm function aids the user in constructing contextually enhanced content in a storytelling format.

7. The method of claim 1, wherein at an administrator site an algorithm function uses cues provided by content providers to intelligently enhance context in a storytelling format.

8. The method of claim 1, wherein at an administrator site the user suggests changes to the added content, wherein the content provider interacts with the suggested changes.

9. The method of claim 1, wherein at an administrator site an algorithm function scans content to determine cues which can be used to enhance context in a storytelling format.

10. The method of claim 1, wherein at an administrator site an algorithm function scans content to determine cues which can be used to enhance context in a storytelling format, wherein the cues include image content, type of device used the add content, ambient audio, time and location page navigation information, geographically locating data, time identifying data, mood identifying data, personally identifying information such as, but not limited to, fingerprints, DNA sequences, identifying reference numbers provided by the content provider or otherwise known, and any combination thereof.

11. The method of claim 1, wherein at an administration site an algorithm function suggests content arrangement, formatting, editing, and addition to the user of the administration site to enhance the storytelling effect.

12. The method of claim 1, wherein at an administration site a module provides functionality to the user of the site to adjust, edit or otherwise change the arrangement and formatting of the content either aided or unaided by the results of the algorithm.

13. A method for composing story content to a page, comprising:
a) at a main page, using a web browser, or like facility, executed by the visitor;
b) displaying in a first browser window a visitor authoring page, the visitor authoring page displaying a graphical user interface for composing content in the visitor defined page, and send command;
c) at a main page, composing content having a variable level of formatting, resulting in visitor content;
d) using the send command to send the visitor content to an administrator site;
e) displaying in a second browser window an administrator page, the administrator page displaying a graphical user interface for approving or rejecting content received by the administrator site, and for optionally formatting content received by the administrator site, an administrator sync method, and an administrator upload method;
f) at an administrator site, approving, rejecting, editing or formatting content received by the administrator site, resulting in administered content;
g) using the sync method, syncing the administered content to an application programming interface (API), wherein the API syncs the administered content with a storytelling rule set to conform the administered content to a storytelling format, resulting in story content;
h) adding the story content to a page.
